(19) United States
(12) Patent Application Publication
(10) Pub. No.: US 2012/0019658 A1
(43) Pub. Date: Jan. 26, 2012

(54) SMART COORDINATOR AND VIDEO SAFEGUARD SYSTEM

(76) Inventors: Sergei Y. Mironichev, Moscow (RU); Christopher C. Mechling, San Diego, CA (US)

(21) Appl. No.: 13/009,715

(22) Filed: Jan. 19, 2011

Related U.S. Application Data
(60) Provisional application No. 61/296,265, filed on Jan. 19, 2010.

(51) Int. Cl. H04N 7/18

(52) U.S. Cl. 348/143; 348/E07.085

(57) ABSTRACT

A smart coordinator or telecommunications module useful for integrating multiple electronic devices, the telecommunications module further coupled to a digital video camera is disclosed herein. A related method of providing smart video surveillance with command and control provided to a smart phone or a computer device is provided herein. In a preferred embodiment, command and control is provided by mobile device technology incorporated to the coordinator. The video camera is supported by a base portion and coupled thereto via a releasable connection and a ball and socket joint. Many advanced features for monitoring a secure area are further provided herein.

### PRIORITY CLAIM

This patent application contains subject matter claiming benefit of the priority date of U.S. Prov. Pat. App. Ser. No. 61/296,265 filed on Jan. 19, 2010 entitled SMART COORDINATOR AND VIDEO SAFEGUARD SYSTEM; accordingly, the entire contents of this provisional patent application is hereby expressly incorporated by reference.

### BACKGROUND OF THE INVENTION

1. Field of the Invention

The present invention relates generally to video surveillance systems for residential and commercial applications. More specifically, the present invention pertains to a system and method for remote surveillance having advanced electronics and wireless network capabilities, and further having additional intelligent features. Additionally in a preferred embodiment, the invention relates to a coordinator module that enhances capabilities of various electronic devices.

2. Description of the Prior Art

Today, it is ever more important to certain individuals, and commercial/government entities to provide security to homes and facilities, in addition to safeguarding valuable items. Recent advancements in electronics and mobile device technology have opened up many possibilities to make numerous devices and networks more intelligent. In general, the improvements are related to the ability to transmit signals in low power and the ability to connect to the Internet via the various cellular devices. The present invention, in a first aspect, seeks to offer innovative methods to improve video surveillance systems. In second aspect, the present invention provides a coordinator module that can mate with various electronic devices to improve functionality thereof.

Therefore, it is an object of the present invention to provide an advanced capability video surveillance system. It is further an object of the present invention to provide a system can be monitored remotely from virtually any location that can attain connectivity to the Internet and/or cellular phone network. It is still further an object of the present invention to provide a system that employs feedback sensors such as motion and audio that further includes wireless transmission capability. It is still further an object of the present invention to provide remote command and control of components such as video cameras and lighting. It is yet still further an object of the present invention to provide a coordinator module that can enhance capabilities of many electronic devices.

These, as well as other advantages of the present invention will be more apparent from the following description and drawings. It is understood that changes in the specific structure shown and described may be made within the scope of the claims, without departing from the spirit of the invention.

### BRIEF SUMMARY OF THE INVENTION

The present invention specifically addresses and alleviates the above mentioned deficiencies associated with the prior art. More particularly, the present invention in a first aspect, the present invention is a video surveillance system comprising: a telecommunications module (also termed smart coordinator herein) comprising: programmable electronics including flash memory and a transceiver and a hardware interface. And further coupled to the telecommunications module is a digital video camera for providing digital images or video to a user via the telecommunications module, the digital video camera further including a hardware interface compatible to the telecommunications module.

The video surveillance in this aspect is additionally characterized wherein, the digital video camera further comprises a hollowed base portion for supporting the digital video camera; an upright portion defining a height of the digital camera; and a camera portion coupled to an upper end of the upright portion, wherein the camera portion together with the hollowed base portion and the upright portion form a “Z” shape in a profile of the digital video camera. Also more specifically, the digital video camera is coupled to the upper end of the upright portion via a releasable connection and a ball and socket joint. Further, the hollowed out base portion houses a battery.

The telecommunications module herein is additionally characterized as further comprising mobile device technology, the mobile device technology chosen from CDMA (code Division Multiple Access) and GSM (Global System for Mobile Communications). Additionally, the telecommunications module further includes low power RF technology, the low power RF technology chosen from wireless protocols commonly known as Bluetooth and ZigBee.

The invention herein in this aspect is additionally characterized as further comprising a smart phone device the smart phone device in communication with the telecommunications module via chosen from a voice over a cellular phone network, an SMS (Short Message Service, or text message), or an MMS (Multimedia Messaging Service), the communication for command and control of the digital video camera.

In another aspect, the invention is characterized as a method of providing video surveillance to an area desired to be monitored, the method comprising: providing a digital video camera; interfacing the digital video camera with a telecommunications module; configuring the telecommunications module to wirelessly transmit data; and transmitting said data to a electronic device configured to receive the data, the electronic device further providing command and control to the video surveillance.

The method herein additionally includes the step of providing security alerts to the electronic device via chosen from SMS, MMS or electronic mail, wherein the electronic device is a smart cellular telephone. The method also includes enhancing the video surveillance by providing audio surveillance to the area with a microphone.

The method of providing video surveillance to an area desired to be monitored is further characterized as including the step of providing wireless connectivity to a motion sensor, a smoke detector, an entrance alarm and a lighting system; and further includes the step of providing feedback and control of the motion sensor, the smoke detector, the entrance alarm and the lighting system. Additional steps include comparing a first image to a second image by the telecommunications module, and transmitting an alert by the telecommunications module to the electronic device based on the comparing images indicating movement.

Further the preferred method herein includes sensing a discharged battery power; and transmitting an alert by the telecommunications module to the electronic device. Still further the method contemplates providing an online store, the online store providing desired applications able to be downloaded and customized by a user.

These, as well as other advantages of the present invention will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective illustration of a digital video device coupled to smart coordinator/telecommunications module of the present invention;

FIG. 2 illustrates an additional perspective view of a coordinator coupled to a digital video device of the present invention;

FIG. 3 illustrates an additional perspective view of the present invention from a side vantage point with the coordinator removed from the video camera and camera removed from its ball and joint connection; and

FIG. 4 illustrates yet another perspective view, this time from a bottom vantage point also revealing a battery compartment of the present invention.

### DETAILED DESCRIPTION OF PREFERRED EMBODIMENTS

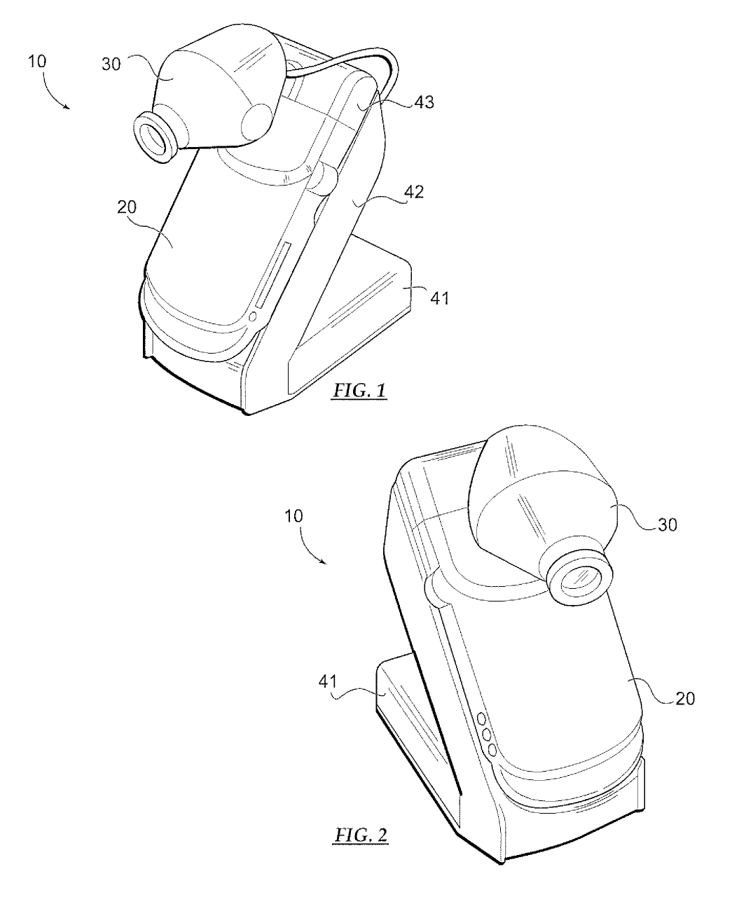

With reference to FIG. 1, a coordinator 20 (or telecommunications module) of the present invention 10 is illustrated also coupled to an electronic video monitor 30. The coordinator 20 plus video equipment will provide the essential components to create an intelligent video surveillance system 10. Initially, the coordinator 20 alone works like a mini-computer having flash memory and processor capability. It further has cellular phone capabilities in addition to low power, short range RF transmission capability (e.g. Bluetooth or ZigBee). Hence, any modern mobile phone is able to be used to monitor and control all system 10 features in addition to any computer with Internet access. Also according to the invention, security alerts can be given to a user selectively in SMS, MMS, and via email. Further the system 10 employs microphones so that a user can listen to any events occurring at the scene remotely via a mobile phone or computer.

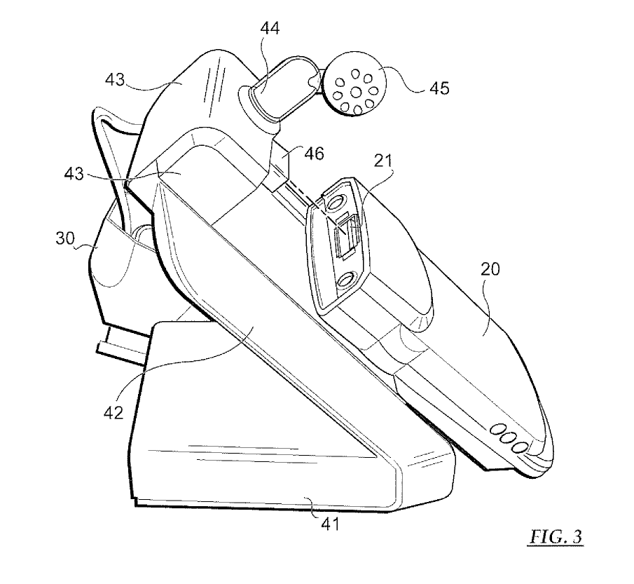

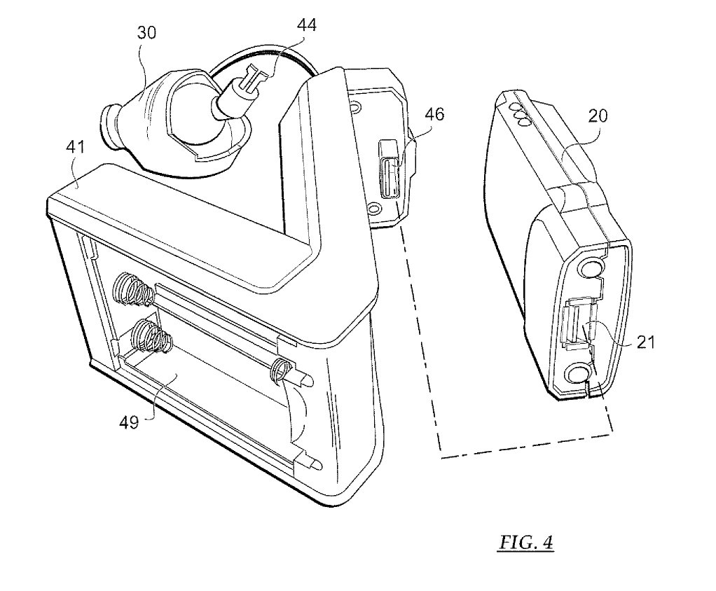

Further with regard to FIG. 2, FIG. 3 and FIG. 4, the invention in a first preferred embodiment includes: a telecommunications module 20 (smart coordinator) that has programmable electronics including flash memory and a transceiver and a hardware interface 21. Additionally further, the telecommunications module 20 is configured to a digital video camera 30 for providing digital images or video to a user via the telecommunications module 20, the digital video camera 30 further including a hardware interface 46 (e.g. USB) compatible to the telecommunications module 21.

Also with regard to FIG. 3 and FIG. 4, the digital video camera 30 further comprises a hollowed 49 (battery compartment) base portion 41 for supporting the digital video camera 30. The base portion 41 is further coupled to an upright portion 42 defining a height of the digital camera 30. A camera portion 30 is coupled to an upper end 43 of the upright portion 42, wherein the camera portion 30 together with the hollowed base portion 41 and the upright portion 42 form a “Z” shape 41, 42, 43, 30 in a profile (FIG. 3) of the digital video camera. Also more specifically, the digital video camera 30 is coupled to the upper end 43 of the upright portion 42 via a releasable connection 44 and a ball and socket joint 45. Further, the hollowed out 49 base portion 41 houses batteries for the device, as shown.

Many additional capabilities are contemplated by the present invention 10 such as providing wireless connectivity to motion sensors, smoke detectors, alarms and lighting systems, providing both feedback and control thereof. The system is programmable and therefore many features can be selectable and predetermined such as the periodic sending of still pictures to a mobile device via MMS, or computer. This feature could be performed ad hoc or automatically.

The present invention further contemplates intelligent video motion sensing. For example, by comparing images a digital video camera 30 could send an alert when it senses movement or alternatively turn on/off, if power 49 consumption is a concern. Similarly, a motion sensor could be mounted to a door of a facility or other structure to either send an alert or to perform another function. In addition to real time monitoring, audio/video can be saved temporarily within the system 10 and streamed to a suitable device upon request.

Further to receiving alerts through various channels, the surveillance system of the present invention is able to be controlled via SMS, email command, audio through a mobile device or through a computer with Internet access. Also, other applications are provided by linking a coordinator to a computer as described herein.

The system also provides various backup and security features. Initially, all interfaces will require password protected access. Also, the system has redundant power sources and any changes to the power system will provide an alert. A separate alert is given in the event of low discharged battery power 49.

It is still further contemplated herein the coordinator 20 of the present invention can be paired to multiple electronic via its USB port 21 and mobile device technology such as CDMA and GSM. At the outset, a coordinator is paired to a personal computer at which point the proper software and drivers are installed to enable the primary interface 21. The invention in this embodiment further provides an online store where desired applications can be downloaded as customized by a user. One such application will expand the capabilities of the personal computer to send and receive phone calls, SMS, and MMS, in addition to sending streaming video from a webcam.

Other applications would include linking Bluetooth devices to the system 10 created by the coordinator 20. Yet another application would allow a user to remotely control his or her computer with another computer or a mobile phone. Another application contemplates configuring the coordinator with a GPS locator and therefore provide tracking of the system with map downloads.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Smart Coordinator and Video Safeguard System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

What is claimed is:

1. A video surveillance system comprising:
a telecommunications module comprising:
programmable electronics including flash memory and a transceiver; and
a hardware interface; and
a digital video camera for providing digital images or video to a user via the telecommunications module, the digital video camera further including a hardware interface compatible to the telecommunications module.

2. The video surveillance system of claim 1, the digital video camera further comprising:
a hollowed base portion for supporting the digital video camera;
an upright portion defining a height of the digital camera; and
a camera portion coupled to an upper end of the upright portion, wherein the camera portion together with the hollowed base portion and the upright portion form a “Z” shape in a profile of the digital video camera.

3. The video surveillance system of claim 1, wherein the digital video camera is coupled to the upper end of the upright portion via a releasable connection and a ball and socket joint.

4. The video surveillance system of claim 1, wherein the hollowed out base portion houses a battery.

5. The video surveillance system of claim 1, the telecommunications module further comprising mobile device technology, the mobile device technology chosen from CDMA and GSM.

6. The video surveillance system of claim 1, the telecommunications module further comprising low power RF technology, the low power RF technology chosen from wireless protocols commonly known as Bluetooth and ZigBee.

7. The video surveillance system of claim 1, further comprising a smart phone device the smart phone device in communication with the telecommunications module via chosen from a voice over a cellular phone network, an SMS, or an MMS, the communication for command and control of the digital video camera.

8. A method of providing video surveillance to an area desired to be monitored, the method comprising:
providing a digital video camera;
interfacing the digital video camera with a telecommunications module;
configuring the telecommunications module to wirelessly transmit data; and
transmitting said data to a electronic device configured to receive the data, the electronic device further providing command and control to the video surveillance.

9. The method of providing video surveillance to an area desired to be monitored of claim 8, further comprising providing security alerts to the electronic device via chosen from SMS, MMS or electronic mail, wherein the electronic device is a smart cellular telephone.

10. The method of providing video surveillance to an area desired to be monitored of claim 8, further comprising enhancing the video surveillance by providing audio surveillance to the area with a microphone.

11. The method of providing video surveillance to an area desired to be monitored of claim 8, further comprising;
providing wireless connectivity to a motion sensor, a smoke detector, an entrance alarm and a lighting system; and
providing feedback and control of the motion sensor, the smoke detector, the entrance alarm and the lighting system.

12. The method of providing video surveillance to an area desired to be monitored of claim 8, further comprising:
comparing a first image to a second image by the telecommunications module; and
transmitting an alert by the telecommunications module to the electronic device based on the comparing images indicating movement.

13. The method of providing video surveillance to an area desired to be monitored of claim 8, further comprising:
sensing a discharged battery power; and
transmitting an alert by the telecommunications module to the electronic device.

14. The method of providing video surveillance to an area desired to be monitored of claim 8, further comprising providing an online store, the online store providing desired applications able to be downloaded and customized by a user.
